(19) United States
(12) Patent Application Publication
(10) Pub. No.: US 2013/0105018 A1
(43) Pub. Date: May 2, 2013

(54) TURBULENCE-INDUCING MIXING DEVICE

(71) Applicants: Ethan G. Sherman, Jacksonville, FL (US); David J. Little, Ponte Vedra, FL (US); Wei Chen, St. Johns, FL (US); John R. Prisco, Jacksonville, FL (US); Matthew J. Friend, St. Augustine, FL (US); Matthew F. Myntti, St. Augustine, FL (US)

(72) Inventors: Ethan G. Sherman, Jacksonville, FL (US); David J. Little, Ponte Vedra, FL (US); Wei Chen, St. Johns, FL (US); John R. Prisco, Jacksonville, FL (US); Matthew J. Friend, St. Augustine, FL (US); Matthew F. Myntti, St. Augustine, FL (US)

(73) Assignee: Medtronic Xomed, Inc.

(21) Appl. No.: 13/284,461

(22) Filed: Oct. 28, 2011

(51) Int. Cl. B01F 5/00

(52) U.S. Cl. 137/896

(57) ABSTRACT

A turbulence-inducing mixing device facilitates mixing, solvating or hydrating materials while passing the materials between fluid delivery devices.

### TECHNICAL FIELD

The invention relates to a mixer for dissolving or hydrating dry materials.

### BACKGROUND

Biomaterials have been used for surgical repair or drug delivery, for example, as tissue sealants in ear, nose and throat (ENT) procedures. The chemical nature of some biomaterial components, however, requires that they remain separated or in dry powdered form until just before use. For example, one or more biomaterials may be mixed shortly before delivery to a desired target site where the biomaterial(s) may rapidly form a gel or solid. A biomaterial component or components may also be provided in dry form (e.g., as a powder) and hydrated or otherwise solubilized or dispersed in water or other liquid carrier before use.

### SUMMARY OF THE INVENTION

Mixing, dissolution or hydration of dry form biomaterials can take time and may involve equipment beyond that required to apply or dispense the biomaterial.

The invention provides, in one aspect, a mixing device comprising:
a) a tubular member having a first opening and a second opening configured to receive a first and a second biomaterial delivery device and place them in fluid communication with each other,
b) at least one mixing element disposed between the first and second openings such that when biomaterials and fluid are passed back and forth between the delivery devices, the biomaterials are mixed with, solubilized or hydrated.

The invention provides, in another aspect, a mixing method which method comprises: providing a mixing device comprising:
a tubular member having a first opening and a second opening configured to receive a first and a second biomaterial delivery device and place them in fluid communication with each other; and
at least one mixing element disposed between the first and second openings; providing a biomaterial in at least the first delivery device and a fluid in at least the second delivery device;
coupling the first delivery device to the first opening and the second delivery device to the second opening; and
passing the biomaterial and fluid back and forth through the mixing device to mix, solubilize or hydrate the biomaterial.

The disclosed device and method have particular utility for reducing the time required to mix, solubilize or hydrate a dry powdered biomaterial. The device and method may provide a simple, easy-to-assemble construction that can permit single-handed assembly, control and operation. Mixing, solvation or hydration may be performed in proximity to the application site, using existing fluid dispensing devices.

### BRIEF DESCRIPTION OF THE DRAWING

FIG. 1 is a perspective view of an exemplary mixing device assembled to delivery devices;

FIG. 2 is a perspective view of the exemplary mixing device shown in FIG. 1;

FIG. 3 is a top view of the FIG. 2 mixing device with four blades; and

FIG. 4 is a top view of the FIG. 2 mixing device with six blades.

Like reference symbols in the various figures of the drawing indicate like elements. The elements in the drawing are not to scale.

### DETAILED DESCRIPTION

The recitation of a numerical range using endpoints includes all numbers subsumed within that range (e.g., 1 to 5 includes 1, 1.5, 2, 2.75, 3, 3.80, 4, 5, etc.).

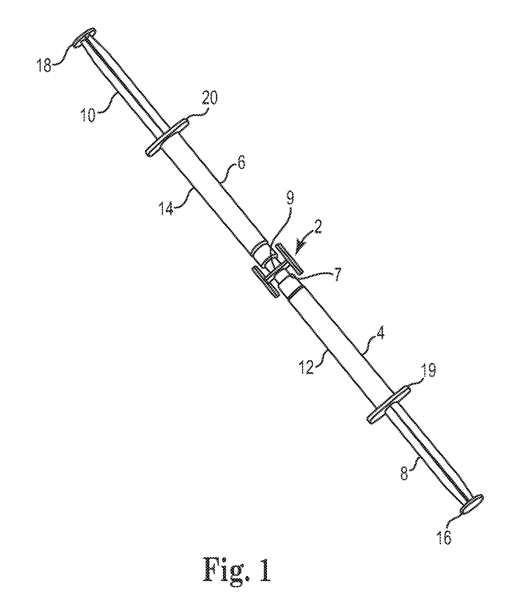

FIG. 1 illustrates a mixing device 2 connecting two delivery devices 4, 6 in the form of standard, commercially available LUER-taper syringes. The syringes 4, 6 initially each hold different components. For example, syringe 4 may be a biomaterial-filled syringe and syringe 6 may be a saline-filled syringe. The mixing device 2 is configured to allow for fluid communication between syringes 4, 6 and production of a homogenous mixture within a short time by alternately depressing syringe plungers 8, 10 to pass the syringe contents back and forth.

Once the syringe contents have become mixed, solubilized or hydrated, the mixing device 2 may be readily detached or removed from the syringes, or remain attached to a single syringe. One or both of the syringes with the mixed or hydrated contents may then be assembled into a suitable delivery system such as that described in co-pending U.S. application Ser. No. (Attorney Docket Nos. P0041646.USU4 and 151-P-41646US04), filed even date herewith and which is incorporated herein by reference in its entirety.

Syringes 4, 6 each have a syringe barrel 12, 14. The syringes 4, 6, can be the same size or can have different sizes, diameters or lengths. Associated with each syringe barrel 12, 14 is a syringe plunger 8, 10 which is inserted into the end of the syringe barrel 12, 14 in standard fashion so that as the syringe plunger 8, 10 is pushed into or pulled out of the syringe barrel 12, 14, the barrel contents are forced into or drawn out of mixing device 2. Each of the plungers 8, 10 has a push flange 16, 18 at the proximal end of the syringe plunger 8, 10. The proximal end of syringe barrels 12, 14 may include, for example, finger support flanges 19, 20. At the distal ends of syringe barrel 12, 14 are syringe dispensing tips 7, 9.

While the mixing device 2 is described as being coupled to syringes containing tissue sealants, other examples e.g. caulk tubes containing two-part adhesives that may need to be mixed or hydrated may be used with the disclosed mixing device.

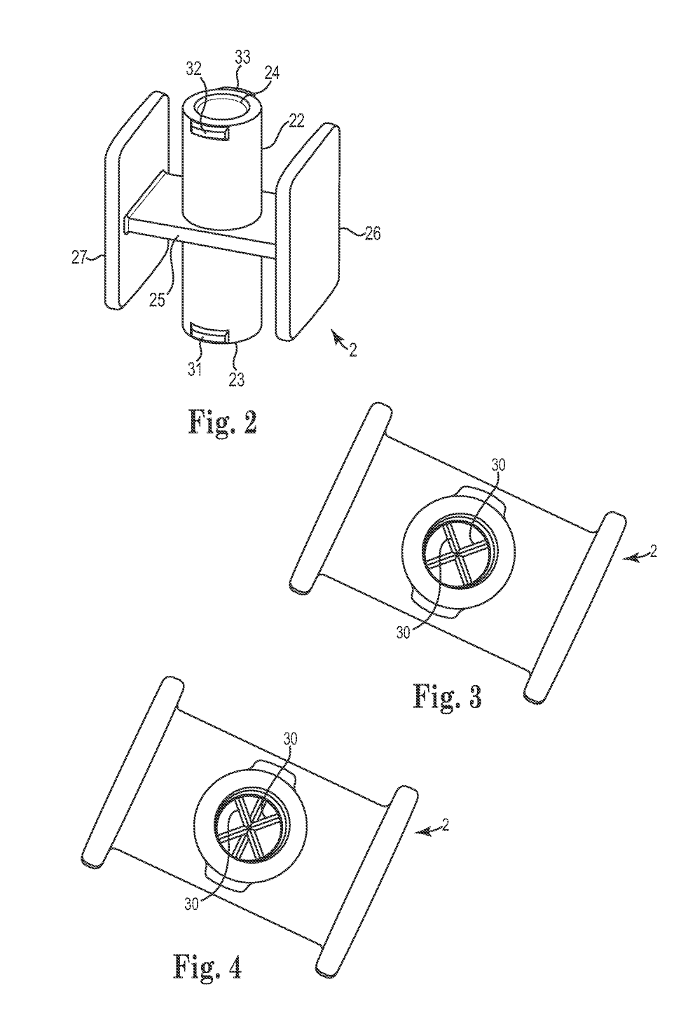

FIGS. 2 and 3 illustrate an exemplary mixing device 2. The mixing device 2 includes a tubular member 22 having a first opening 23 and a second opening 24. The first opening 23 and second opening 24 are configured to receive dispensing tips of syringes 4, 6 and to allow passage of the fluid components between syringes 4, 6.

The mixing device 2 desirably includes a finger grip 25 provided by an H-like or a cross-like element that projects laterally from tubular member 22 and provides at least one and preferably two grip surfaces 26, 27 that can be held between an operator's thumb and fingers.

FIG. 3 illustrates a plurality of mixing elements 30 inside mixing device 2. These mixing elements 30 may be in the form of fins, blades or other turbulence-inducing fluid path obstructions for materials moving through the tubular member 22. The mixing elements 30 may include, for example 1 to 10 blades or fins, which may be configured, for example, to form an H, an X as shown in FIG. 3, or other desired configuration. FIG. 4 shows the fins or blades configured with 6 blades. Four blades mean four blades or two blades that cross over each other to form four sections or regions. Likewise, six blades mean six blades or three blades that cross over each other, to form six sections or regions. The mixing elements 30 can also be stacked on top of each other and curved or angled to direct materials passing through the mixing device 2 in different directions to facilitate mixing, solubilizing or hydration of the material.

The first opening 23 and second opening 24 of tubular member 22 are further configured to mate with the syringe dispensing tips 7, 9 to provide a suitable coupling, for example, a press fit, snap-fit, tapered (e.g., LUER-SLIP™), or bayonet-lock (e.g., LUER-LOK™) relationship. For example, the edge of the second opening 24 may include projections 32, 33 that allow for a bayonet lock with syringes 4, 6. The openings 23 and 24 preferably include a female internal LUER™ tapered portion to facilitate assembling the mixing device 2 over a corresponding male LEUR™ tapered portion of a standard disposable syringe to provide a water tight seal. Such couplings allow the mixing device 2 to be readily detached or removed from both the delivery devices or a single delivery device.

A variety of different materials may be mixed using mixing device 2, including liquid-liquid, powder-powder or powder-liquid combinations. For example, the materials to be mixed, solubilized or hydrated may be biocompatible or biodegradable materials mixed, solubilized or hydrated with saline. Such materials may include tissue sealants such as polysaccharides, for example, mixtures of chitosan or chitosan derivatives with starch or starch derivatives. Other exemplary tissue sealants are provided in U.S. patent application Ser. No. 12/429,141, now published as U.S. Publication No. 2009/0270346A1 and U.S. patent application Ser. No. 12/429,150, now published as U.S. Publication No. 2009/0291912A1.

The mixing device 2 may be made of a variety of materials, including thermosets such as polycarbonates and nylons, thermoplastics such as polyolefins (e.g. polyethylene and polypropylene), elastomers such as NEOPRENE™, SANTAPRENE™, rubbers or silicone elastomers, or nonorganic materials including glass, ceramics or metals. Depending on the chosen material, mixing device 2 may be injection-molded or machined.

Mixing, solubilizing or hydrating of the materials in the syringes 4, 6 may, for example, be initiated by depressing the syringe plunger 8, thereby forcing the material from the syringe barrel 12 into the syringe barrel 14 via the mixing device 2 or by withdrawing syringe plunger 10, thereby drawing material from the syringe barrel 12 into the syringe barrel 14 via the mixing device 2. Material motion back and forth between syringes 4, 6 is continued until the desired degree of mixing, solubilizing or hydration occurs. The force required for the back and forth material motion may, for example, be less than 12 pounds, less than 6 pounds, and preferably less than 4 lbs. The mixing, solvation or hydration may occur, for example, when the components pass the mixing elements at least once, twice, thrice, or four times, preferably 10-20 times, and desirably mixing, solvation or hydration is complete within 18 minutes or less, within 16 minutes or less, within 14 minutes or less, within 12 minutes or less, and preferably within 1 minute or less.

The invention is further illustrated in the following non-limiting example.

### EXAMPLE 1

3 ml plastic disposable syringes containing 3 ml of saline in one syringe and 85 mg of dry, powdered chitosan in another were connected to a mixing device with different blade numbers. The contents were mixed back and forth 20 times and the contents were visually inspected at one minute intervals until the material was completely hydrated (when the solution turns from cloudy to a clear solution). The hydration time following mixing 20 times was measured and the results are shown in the table below.

| | Mixing or Hydration |
|---|---|
| Blade Design | Time (minutes) |
| Comparative Example (no blades) | 26 |
| 4 Blades¹ | 15-16 |
| 6 Blades² | 13-14 |

¹The 4 blades are configured as shown in FIG. 3.
²The 6 blades are configured as shown in FIG. 4.

The above results show that the mixing time decreases by at least 38% using a 4-blade mixer compared to the control (no blades).

### EXAMPLE 2

3 ml BD plastic disposable syringes (available from Becton Dickinson) containing 3 ml of saline in one syringe and 85 mg of dry, powdered chitosan or 300 mg oxidized starch in another were connected to a mixing device with 4 blades. Mixing device 2 with material or solution-filled syringes 4 and 6 assembled was clamped into a suitable fixture and evaluated using a calibrated force gauge to determine hydration forces in Lbf units. The material was passed from one syringe to the other 5 times. The force required to depress the plunger and pass the material to the other syringe was recorded. Each test was conducted 14 times.

| Test Description | Average (Lbf) | STDEV |
|---|---|---|
| Chitosan Hydration Force | 2.96 | 0.43 |
| Starch Hydration Force | 3.31 | 0.36 |

We claim:

1. A mixing device comprising:
a) a tubular member having a first opening and a second opening configured to receive a first and a second biomaterial delivery device and place them in fluid communication with each other,
b) at least one mixing element disposed between the first and second openings such that when biomaterials and fluid are passed back and forth between the delivery devices, the biomaterials are mixed with, solubilized or hydrated.

2. The mixing device of claim 1 wherein the mixing device is detachably connected to the first and second delivery devices.

3. The mixing device of claim 1 wherein the mixing device provides a press-fit, snap fit or bayonet lock fit to the first and second delivery devices.

4. The mixing device of claim 1 wherein the mixing device comprises polypropylene or polyethylene.

5. The mixing device of claim 1 wherein the first and second delivery devices comprise syringes.

6. The mixing device of claim 1 wherein the first and second delivery device contain a tissue sealant.

7. The mixing device of claim 1 wherein the first delivery device contains chitosan, a chitosan derivative, or starch and the second delivery device contains saline.

8. The mixing device of claim 1 wherein the mixing elements comprises fins or blades.

9. The mixing device of claim 1 wherein the mixing elements comprise 1-10 mixing elements.

10. The mixing device of claim 1 wherein the mixing elements comprises 4 blades or 4 sections.

11. A method of mixing or hydrating materials which method comprises:
providing a mixing device comprising:
a tubular member having a first opening and a second opening configured to receive a first and a second biomaterial delivery device and place them in fluid communication with each other; and
at least one mixing element disposed between the first and second openings;
providing a biomaterial in at least the first delivery device and a fluid in at least the second delivery device;
coupling the first delivery device to the first opening and the second delivery device to the second opening; and
passing the biomaterial and fluid back and forth through the mixing device to mix, solubilize or hydrate the biomaterial.

12. The method of claim 11 comprising attaching the first and second delivery devices to the mixing device via a press-fit, snap fit or bayonet lock fit.

13. The method of claim 11 wherein the mixing device comprises polypropylene or polyethylene.

14. The method of claim 11 wherein the first and second delivery devices comprise syringes.

15. The method of claim 11 wherein the mixing elements comprises fins or blades.

16. The method of claim 11 wherein the mixing elements comprise 1-10 mixing elements.

17. The method of claim 11 wherein the mixing elements comprise 4 blades or 4 sections.

18. The method of claim 11 comprising mixing, solvating or hydrating chitosan or starch.

19. The method of claim 11 comprising mixing the materials with force less than 6 Lbf.
